(19) United States
(12) Patent Application Publication
(10) Pub. No.: US 2021/0056740 A1
(43) Pub. Date: Feb. 25, 2021

(54) Influencing Factor Mixture Range Analysis Method and Influencing Factor Mixture Range Analysis Device

(71) Applicant: Nippon Telegraph and Telephone Corporation, Tokyo (JP)

(72) Inventors: Masahiro Sotoma, Musashino-shi, Tokyo (JP); Soichi Oka, Musashino-shi, Tokyo (JP)

(21) Appl. No.: 17/043,870

(22) PCT Filed: Apr. 2, 2019
(86) PCT No.: PCT/JP2019/014591

§ 371 Date: Sep. 30, 2020

(30) Foreign Application Priority Data
Apr. 5, 2018 (JP) 2018-073073

(51) Int. Cl. G06T 11/20; G06T 3/40

(52) U.S. Cl. CPC G06T 11/206; G06T 3/40

(57) ABSTRACT

The purpose of the present invention is to enable mixture data in which different influencing factors are mixed to be stratified depending on influencing factor in failure analysis. A range setting unit 11 divides an area to be analyzed into meshes, and divides the area to be analyzed into a group A and a group B in the smallest unit of the mesh. An analysis unit 12 uses inspection data on facilities X present in the meshes in the group A to perform Weibull distribution by a cumulative hazard method. A determination unit 13 uses the degree of deviation of the plots based on the Weibull distribution from a regression line as an index to determine whether the group A is a mixed area or a single area. A range enlargement unit 14 repeats processing for shifting meshes from the group B to the group A while keeping the group A to be a single area.

### TECHNICAL FIELD

The present invention relates to a technology for estimating, when performing analysis such as Weibull distribution on articles or facilities whose influencing factors for deterioration and failures are unknown, a range in which the influencing factors are mixed or a range in which the influencing factors are not mixed.

### BACKGROUND ART

In analysis on deterioration and failures of articles and facilities (hereinafter referred to as “failure analysis”), it is common practice to perform reliability analysis such as Weibull distribution and cumulative hazard analysis. The reliability analysis is analysis on the relation between an index indicating deterioration of a target such as the occurrence of a failure and an index considered to relate to the deterioration such as operating time. The results of the analysis can be expressed as a plot graph such as Weibull probability paper. When the plots are along a regression line as a whole, an analysis target can be regarded as being able to be analyzed by this analysis method, and parameters and function expressions useful for failure analysis can be derived as a result.

On the other hand, when the plot are not along the regression line and are bent, it is interpreted that the analysis method is inappropriate or that failures and deterioration due to different causes or different influencing factors are mixed in analysis data (hereinafter referred to as “mixture data”). When analysis data is mixture data, the analysis data may be divided (stratified) depending on influencing factors, and Weibull distribution may be performed on each of the pieces of data (NPL 1).

### CITATION LIST

### Patent Literature

[PTL 1] WO 03/085548
[PTL 2] Japanese Patent Application Publication No. H 10-034122
[PTL 3] Japanese Patent Application Publication No. 2003-331087
[PTL 4] Japanese Patent No. 6178277

### Non Patent Literature

[NPL 1] Kenji Tanaka, “Nyuumon Shinrai-sei” (Introduction: Reliability), pp. 93-94, JUSE Press, Ltd.

### SUMMARY OF THE INVENTION

### Technical Problem

It is, however, sometimes difficult to specify an influencing factor affecting failures and deterioration. For example, when an analysis target is installed outdoors, there may be various influencing factors, and it may be difficult to specify and estimate the ranges where influencing factors are present. In such a case, mixture data cannot be stratified depending on influencing factors for the first place.

Most of the conventional technologies related to Weibull distribution are targeted at how the results of Weibull distribution are used (for example, PTL 1 to 3), and do not take countermeasures against the deviation of plots of results such as Weibull distribution from a regression line.

PTL 4 indicates a method for using the existence probability of an influencing factor to obtain information contributing the countermeasures against the deviation of plots such as Weibull distribution from a regression line. Unlike the present proposal, however, this method does not estimate a range in which different influencing factors are not mixed, and does not enable the stratification of mixture data.

The present invention has been made in view of the above, and it is an object thereof to enable mixture data in which different influencing factors are mixed to be stratified depending on influencing factor in failure analysis.

### Means for Solving the Problem

An influencing factor mixture range analysis method to be executed by a computer according to the present invention includes: a step of setting a first area in an area to be analyzed; a step of analyzing a relation between an index indicating deterioration of a target in the first area and an index considered to relate to the deterioration; a step of determining whether the first area is an area in which different influencing factors are not mixed by using a degree of deviation of plots of a result of the analysis from a regression line as an index; and a step of enlarging the first area until the first area reaches a predetermined size while keeping the first area to be an area in which different influencing factors are not mixed.

An influencing factor mixture range analysis device according to the present invention includes: setting means for setting a first area in an area to be analyzed; analysis means for analyzing a relation between an index indicating deterioration of a target in the first area and an index considered to relate to the deterioration; determination means for determining whether the first area is an area in which different influencing factors are not mixed by using a degree of deviation of plots of a result of the analysis from a regression line as an index; and enlargement means for enlarging the first area until the first area reaches a predetermined size while keeping the first area to be an area in which different influencing factors are not mixed.

### Effects of the Invention

According to the present invention, mixture data in which influencing factors are mixed can be stratified depending on influencing factors in failure analysis.

### BRIEF DESCRIPTION OF DRAWINGS

FIG. 1 is a diagram illustrating an example of an area to be analyzed in which facilities X are dispersedly arranged outdoors.

FIG. 2 is a diagram illustrating plots of Weibull distribution using inspection data on facilities X in the entire area to be analyzed and a regression line.

FIG. 3 is a functional block diagram illustrating a configuration of an influencing factor mixture range analysis device in this embodiment.

FIG. 4 is a diagram illustrating how the area to be analyzed in FIG. 1 is divided into meshes and divided into two groups.

FIG. 5 is a diagram illustrating an example of a determined single area.

FIG. 6 is a diagram illustrating plots of Weibull distribution of the determined single area and a regression line.

FIG. 7 is a diagram illustrating plots of Weibull distribution of areas other than the determined single area and a regression line.

FIG. 8 is a flowchart illustrating the flow of processing by the influencing factor mixture range analysis device in this embodiment.

### DESCRIPTION OF EMBODIMENTS

An embodiment of the present invention is described below with reference to the drawings.

Outline of Influencing Factor Mixture Range Analysis

Targets in this embodiment are facilities X dispersedly arranged outdoors in a wide area.

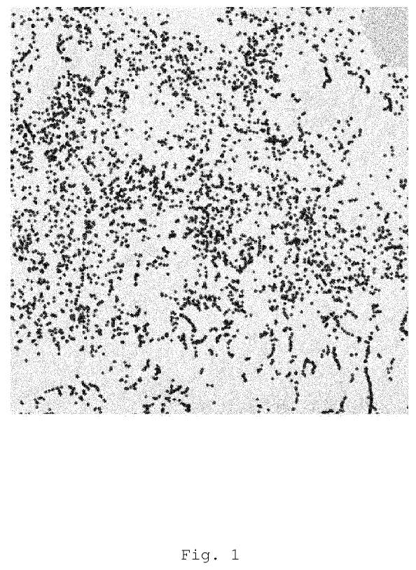

FIG. 1 is a diagram illustrating an example of an area to be analyzed in which facilities X are dispersedly arranged outdoors. Dots in FIG. 1 indicate positions at which the facilities X are installed.

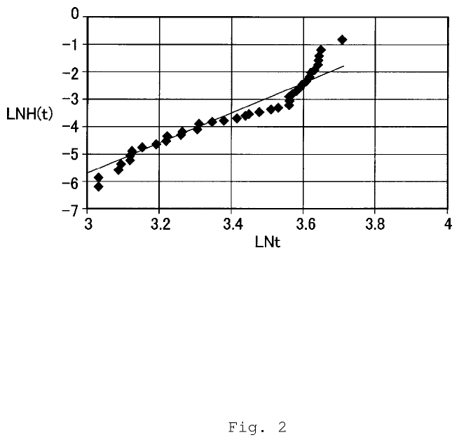

FIG. 2 illustrates plots of Weibull distribution by a cumulative hazard method using inspection data on facilities X in the entire area to be analyzed. In FIG. 2, the horizontal axis indicates a log value Log t of the age of service t of the facility X, and the vertical axis indicates a cumulative hazard value H(t) at the age of service t. The line in FIG. 2 is a regression line of the plots.

It is understood from FIG. 2 that the plots deviate from the regression line and are bent. This suggests that inspection data used for the analysis is mixture data including deterioration and failures caused by different influencing factors. However, an influencing factor to bend the plots is not clarified, and hence the mixture data cannot be stratified.

In view of the above, in this embodiment, any range is selected from the area to be analyzed, and reliability analysis is performed on inspection data on facilities X present in the selected range. The range is expanded such that the plots of the analysis result do not deviate from the regression line, and an area in which the plots are not bent, that is, an area in which the plots are well along the regression line, is specified. Hereinafter, the area in which the plots are not bent is referred to as “single area”, and the area in which the plots are bent is referred to as “mixed area”. The single area is considered to indicate an area in which deterioration and failures caused by different influencing factors are not mixed. By comparing characteristics in the single area, such as geometric features, with those in other areas, information contributing to the specification of a factor affecting deterioration and failures of a target is obtained.

Configuration of Influencing Factor Mixture Range Analysis Device

Next, a configuration of an influencing factor mixture range analysis device in this embodiment is described.

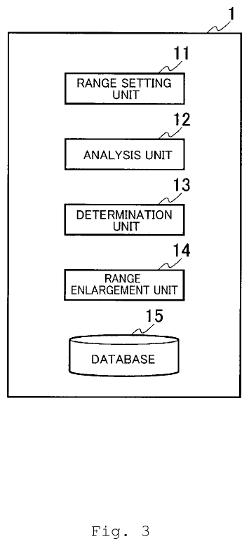

FIG. 3 is a functional block diagram illustrating the configuration of the influencing factor mixture range analysis device in this embodiment. An influencing factor mixture range analysis device 1 illustrated in FIG. 3 includes a range setting unit 11, an analysis unit 12, a determination unit 13, a range enlargement unit 14, and a database 15. The units in the influencing factor mixture range analysis device 1 may be configured by a computer including an arithmetic processing unit and a storage device, and processing of the units may be executed by a program. The program is stored in the storage device in the influencing factor mixture range analysis device 1, and may be recorded in a recording medium such as a magnetic disk, an optical disc, or a semiconductor memory and may be provided through a network.

The range setting unit 11 divides an area to be analyzed into third-order meshes, which are one of standard area meshes, to divide the area to be analyzed into two groups (hereinafter referred to as “group A” and “group B”) in the smallest unit of the mesh. In this embodiment, the area to be analyzed is divided into third-order meshes, but the area to be analyzed may be divided by another method. Any method can be employed for the first grouping. For example, some adjacent meshes are selected to create a group A, and a group of meshes that do not belong to the group A is set as a group B.

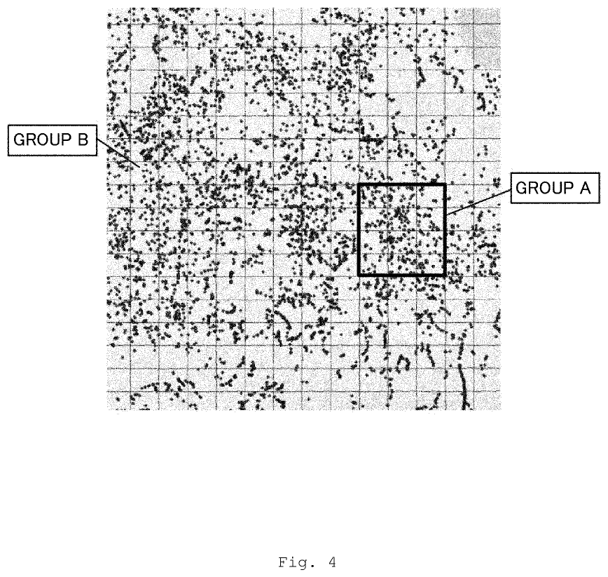

FIG. 4 illustrates how the area to be analyzed is divided into meshes and divided into two groups. Rectangles in FIG. 4 represent third-order meshes. Meshes in the thick line belong to the group A. Meshes that do not belong to the group A are the group B.

In the group A formed of only some adjacent meshes, installation environments are highly possibly similar, and hence as compared with the case where all areas are collectively analyzed, the possibility that different influencing factors are mixed is low. In other words, the group A is more highly possibly a single area. Note that, when the group A set in the first grouping is a mixed area rather than a single area, other meshes are used to set the group A again. When the group A set in the first grouping is a single area, the group is employed as the group A. Whether the group A is a single area is determined by the determination unit 13 on the basis of the analysis result by the analysis unit 12.

The analysis unit 12 uses inspection data on facilities X present in the meshes in the group A to perform Weibull distribution by a cumulative hazard method, and creates a plot whose axes are a log value Log t of the age of service t of the facility X and a cumulative hazard value H(t) at the age of service t, and determines a regression line. The Weibull distribution by the cumulative hazard method may be performed by a known method, and may be another known analysis method matching the analysis target and the nature of analysis data. The axes of the plots are not limited to the age of service and the cumulative hazard value. The axes only need to be an index indicating deterioration of a target and an index considered to relate to the deterioration, and may conform to various kinds of known probability paper. The regression line may be determined by a known method.

Note that the Weibull distribution of the group B is not essential, but the Weibull distribution of the group B is also useful because a change in plots in the group B can be grasped after shifting meshes.

The determination unit 13 uses the degree of deviation of the plots based on the Weibull distribution from the regression line as an index to determine whether the group A is a mixed area or a single area. For the index of the degree of deviation of the plots from the regression line, conventional methods such as the value of the coefficient of determination and the maximum deviation may be utilized. In this embodiment, when a coefficient of determination R2 is 0.98 or more, it is determined that the plots are along the regression line, that is, the group is a single area.

After setting the first group A, the range enlargement unit 14 repeats processing for shifting meshes (for example, one to several meshes) from the group B to the group A while confirming that the group A is a single area. More specifically, after the range enlargement unit 14 shifts meshes from the group B to the group A, the analysis unit 12 analyzes the group A after the shifting of the meshes, and the determination unit 13 determines whether the group A after the shifting of the meshes is a single area on the basis of the analysis result by the analysis unit 12. When the group A after the shifting of the meshes is a single area, the range enlargement unit 14 employs the shifted meshes as the group A. When the group A after the shifting of the meshes is no longer a single area, the range enlargement unit 14 returns the shifted meshes to the group B. The range enlargement unit 14 repeats the above-mentioned processing until the group A has reached a target size (such as the largeness and the number of meshes). The target size may be set depending on the purpose. However, there is a possibility that the group A does not reach a set target size, and hence the setting of the target size is variable.

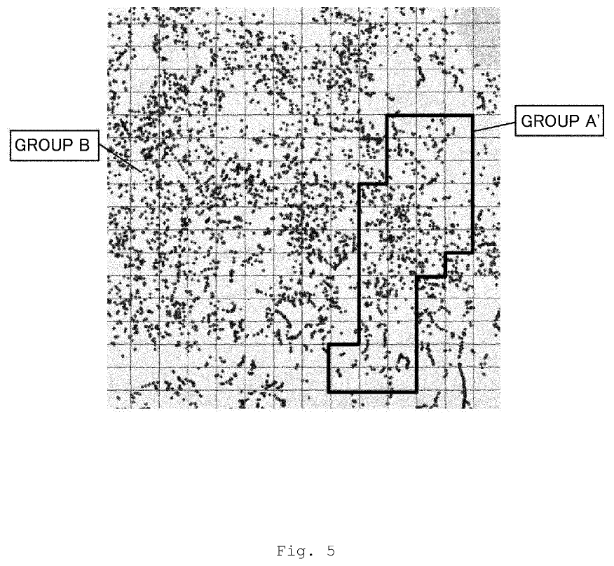

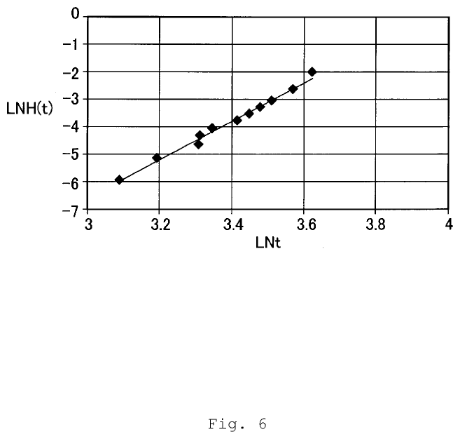

When the group A has reached the target size, the range enlargement unit 14 determines the range of the single area by replacing the group A with a group A′. FIG. 5 illustrates an example of the determined range of the group A′. FIG. 6 illustrates plots of Weibull distribution of the determined group A′. It is understood from FIG. 6 that the plots of the group A′ are well along the regression line.

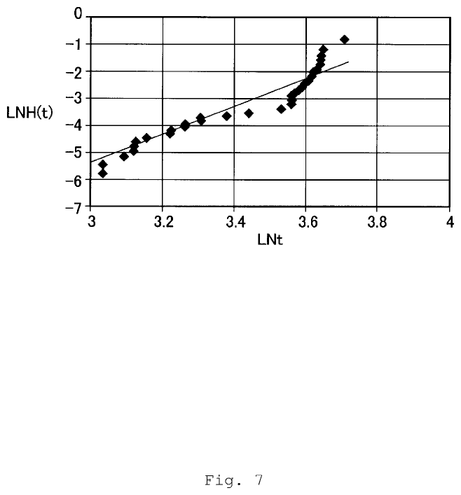

FIG. 7 illustrates plots of Weibull distribution of the group B. In many cases, the group B is still a mixed area even after the group A′ is determined as a single area. After the group A′ is determined, the range setting unit 11 may divide the group B as the next area to be analyzed into two groups, and determine a group B′ as a new single area. After the group B′ is determined, the range setting unit 11 may similarly repeats processing for determining a group C′, a group D′, . . . .

The database 15 stores therein positional information on facilities X arranged in an area to be analyzed and data necessary for reliability analysis such as inspection data.

Operation of Influencing Factor Mixture Range Analysis Device

Next, the operation of the influencing factor mixture range analysis device in this embodiment is described.

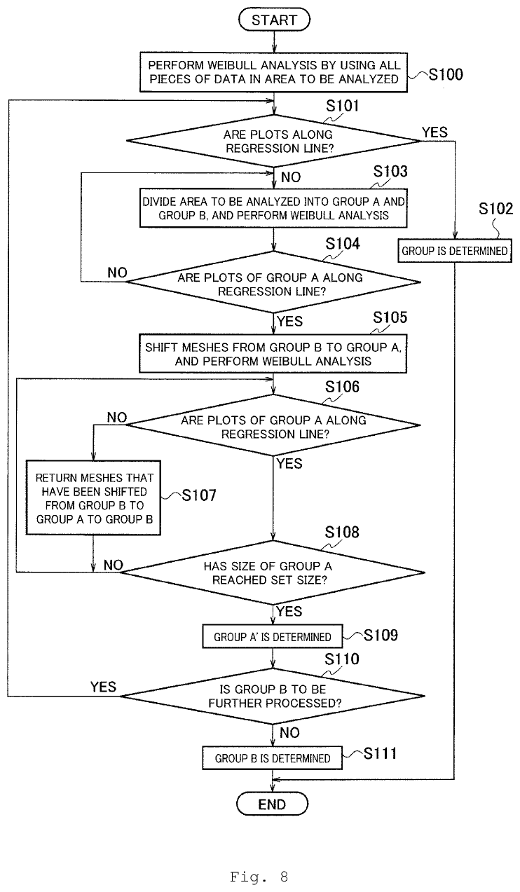

FIG. 8 is a flowchart illustrating the flow of processing by the influencing factor mixture range analysis device 1 in this embodiment.

At Step S100, the analysis unit 12 performs Weibull distribution by using all pieces of inspection data in an area to be analyzed that are stored in the database 15.

At Step S101, the determination unit 13 determines whether plots by the Weibull distribution are along a regression line. When the plots are along the regression line (Yes at Step S101), the flow proceeds to Step S102. When the plots are not along the regression line (No at Step S101), the flow proceeds to Step S103. Note that, when returned from Step S109 described later, the determination unit 13 determines whether plots by Weibull distribution of a group (for example, group B) that has not been determined as a single area are along the regression line. When the flow returns from Step S109, in the following description, the alphabets for identifying the groups are read while being sequentially shifted. Specifically, the group A is read as a group B, the group A′ is read as a group B′, and the group B is read as a group C. After the third cycle, similarly, the alphabets for identifying the groups are read while being sequentially shifted.

At Step S102, the range setting unit 11 does not need to stratify the inspection data in the area to be analyzed, and hence determines the entire area to be analyzed as a group of a single area.

At Step S103, the range setting unit 11 divides the area to be analyzed into a group A having a freely selected small range and a group B having another range, and the analysis unit 12 performs Weibull distribution of the group A.

At Step S104, the determination unit 13 determines whether plots of analysis results of the group A are along the regression line. When the plots are along the regression line (Yes at Step S104), the flow proceeds to Step S105. When the plots are not along the regression line (No at Step S104), the flow proceeds to Step S103, and the range setting unit 11 sets the range of the group A again.

At Step S105, the range enlargement unit 14 newly shifts meshes from the group B to the group A, and the analysis unit 12 performs Weibull distribution of the group A after the shifting of the meshes. Note that, when returned from Step S107 described later, the range enlargement unit 14 shifts a mesh different from the mesh returned to the group B from the group B to the group A.

At Step S106, the range enlargement unit 14 determines whether plots of analysis results of the group A after the shifting of the meshes are along the regression line. When the plots are along the regression line (Yes at Step S106), the flow proceeds to Step S108. When the plots are not along the regression line (No at Step S106), the flow proceeds to Step S107.

At Step S107, the range enlargement unit 14 returns the meshes that have been shifted from the group B to the group A at the previous Step S105 to the group B, and the flow proceeds to Step S105.

At Step S108, the range enlargement unit 14 determines whether the size of the group A has reached a target size set in advance. When the group A has reached the target size (Yes at Step S108), the flow proceeds to Step S109. When the group A has not reached the target size (No at Step S108), the flow proceeds to Step S105, and the processing for shifting meshes from the group B to the group A is repeated.

At Step S109, the range enlargement unit 14 determines the group A′ as a single area.

At Step S110, the range setting unit 11 determines whether to perform the processing of Steps S101 to S109 on the group B, which has not been determined as a single area. When the processing is performed on the group B (Yes at Step S110), the flow proceeds to Step S101. When the processing is not performed on the group B (No at Step S110), the flow proceeds to Step S111.

At Step S111, the range setting unit 11 determines the group B.

The single areas (group A′, group B′, group C′ . . . ) determined by the processing described above are the ranges in which influencing factors are not mixed to such a degree that deterioration and failures of a target can be analyzed by Weibull distribution. In other words, the mixture data can be stratified, and failure analysis based on the Weibull distribution can be performed. The comparison between the determined single area and a mixed area or between the determined single areas can contribute to the specification of a factor affecting deterioration and failures of an analysis target.

In the description of this embodiment, an area to be analyzed is an area on a two-dimensional plane assuming the ground, but the area to be analyzed may be a three-dimensional space. Further, a multidimensional area may be conceptually analyzed in terms of data.

As described above, according to this embodiment, the range setting unit 11 divides an area to be analyzed into meshes, and divides the area to be analyzed into a group A and a group B in the smallest unit of the mesh. The analysis unit 12 uses inspection data on facilities X present in the meshes of the group A to perform Weibull distribution by a cumulative hazard method. The determination unit 13 uses the degree of deviation of plots by the Weibull distribution from a regression line as an index to determine whether the group A is a mixed area or a single area. Further, the range enlargement unit 14 repeats processing for shifting meshes from the group B to the group A while keeping the group A to be a single area. The processing described above enables a single area in which deterioration and failures caused by different influencing factors are not mixed to be specified, and enables the stratification of mixture data in failure analysis based on the Weibull distribution, thereby being capable of performing analysis. The range to which each piece of stratified data belongs, for example, an area, can be clarified, and hence an effect contributing to the specification and estimation of influencing factors affecting deterioration and failures can be obtained.

### REFERENCE SIGNS LIST

1 Influencing factor mixture range analysis device
11 Range setting unit
12 Analysis unit
13 Determination unit
14 Range enlargement unit
15 Database

1. An influencing factor mixture range analysis method to be executed by a computer, comprising:
a step of setting a first area in an area to be analyzed; a step of analyzing a relation between an index indicating deterioration of a target in the first area and an index considered to relate to the deterioration;
a step of determining whether the first area is an area in which different influencing factors are not mixed by using a degree of deviation of plots of a result of the analysis from a regression line as an index; and
a step of enlarging the first area until the first area reaches a predetermined size while keeping the first area to be an area in which different influencing factors are not mixed.

2. The influencing factor mixture range analysis method according to claim 1, wherein the step of setting a first area includes dividing the area to be analyzed into meshes, selecting some of the meshes adjacent to each other to set the first area, and setting a second area formed by meshes that do not belong to the first area, and the step of enlarging the first area includes shifting the mesh from the second area to the first area, determining whether the first area after the shifting of the mesh is an area in which different influencing factors are not mixed, and when the first area after the shifting of the mesh is not an area in which different influencing factors are not mixed, returning the shifted mesh to the second area.

3. An influencing factor mixture range analysis device, comprising: setting means for setting a first area in an area to be analyzed; analysis means for analyzing a relation between an index indicating deterioration of a target in the first area and an index considered to relate to the deterioration; determination means for determining whether the first area is an area in which different influencing factors are not mixed by using a degree of deviation of plots of a result of the analysis from a regression line as an index; and enlargement means for enlarging the first area until the first area reaches a predetermined size while keeping the first area to be an area in which different influencing factors are not mixed.

4. The influencing factor mixture range analysis device according to claim 3, wherein the setting means divides the area to be analyzed into meshes, selects some of the meshes adjacent to each other to set the first area, and sets a second area formed by meshes that do not belong to the first area, and the enlargement means shifts the mesh from the second area to the first area, and when the first area after the shifting of the mesh is not an area in which different influencing factors are not mixed, returns the shifted mesh to the second area.
